(19) United States
(12) Patent Application Publication
(10) Pub. No.: US 2026/0190068 A1
(43) Pub. Date: Jul. 2, 2026

(54) Methods, Apparatus and Computer-Readable Media for Enabling Performance of Sidelink Positioning of a Target UE using a Plurality of Reference UEs

(71) Applicant: Telefonaktiebolaget LM Ericsson (publ), Stockholm (SE)

(72) Inventors: Min Wang, Luleå (SE); Ritesh Shreevastav, Upplands Väsby (SE)

(21) Appl. No.: 19/126,157

(22) PCT Filed: Oct. 30, 2023
(86) PCT No.: PCT/SE2023/051077

§ 371 Date: Apr. 30, 2025

Related U.S. Application Data
(60) Provisional application No. 63/422,209, filed on Nov. 3, 2022.

(51) Int. Cl. H04W 64/00; H04W 72/044; H04W 72/25; H04W 72/543

(52) U.S. Cl. CPC H04W 64/00; H04W 72/044; H04W 72/25; H04W 72/543

(57) ABSTRACT

Embodiments described herein relate to methods and apparatuses for enabling performance of sidelink, SL, positioning of a target UE using a plurality of reference UEs. A method in a first controlling user equipment, UE, comprises: determining one or more inter-UE coordination, IUC, messages relating to resource reservation for the plurality of reference UEs; and transmitting the one or more IUC messages to the plurality of reference UEs.

### TECHNICAL FIELD

Embodiment described herein relate to methods and apparatuses for enabling performance of sidelink, SL, positioning of a target user equipment, UE, using a plurality of reference UEs.

### BACKGROUND

### Positioning in Uu

Positioning has been a topic in Long Term Evolution (LTE) standardization since the 3^{rd} Generation Partnership Project (3GPP) Release 9. The primary objective is to fulfill regulatory requirements for emergency call positioning. Positioning in New Radio (NR) is proposed to be supported by the architecture shown in FIG. 1. A Location Management Function (LMF) is the location node in NR. There are also interactions between the location node and the gNodeB via the NRPPa protocol. The interaction between the gNodeB and the device is supported via the Radio Resource Control (RRC) protocol.

The gNB and ng-eNB may not always both be present. When both the gNB and ng-eNB are present, the NG-C interface is only present for one of them.

In the legacy LTE standards, the following techniques are supported:
Enhanced Cell ID: Which may comprise cell ID information to associate the device to the serving area of a serving cell, and then additional information to determine a finer granularity position.
Assisted Global Navigation Satellite System (GNSS): GNSS information retrieved by the device, supported by assistance information provided to the device from Enhanced Serving Mobile Location Center (E-SMLC).
OTDOA (Observed Time Difference of Arrival): The device estimates the time difference of reference signals from different base stations and sends to the E-SMLC for multilateration.
UTDOA (Uplink Time Difference of Arrival (TDOA)): The device is requested to transmit a specific waveform that is detected by multiple location measurement units (e.g. an eNB) at known positions. These measurements are forwarded to E-SMLC for multilateration.
Sensor methods such as Biometric pressure sensor which provides vertical position of the device and Inertial Motion Unit (IMU) which provides displacement.

NR supports the below Radio Access Technology (RAT) Dependent positioning methods:

Downlink TDOA (DL-TDOA): The DL TDOA positioning method makes use of the Downlink (DL) Reference Signal Time Difference (RSTD) (and optionally DL Positioning Reference Signal (PRS) Reference Signal Received Power (RSRP)) of downlink signals received from multiple (Transmission Points) TPs, at the UE. The UE measures the DL RSTD (and optionally DL PRS RSRP) of the received signals using assistance data received from the positioning server, and the resulting measurements are used along with other configuration information to locate the UE in relation to the neighbouring TPs.

Multi-Round Trip Time (RTT): The Multi-RTT positioning method makes use of the UE Rx-Tx measurements and DL PRS RSRP of downlink signals received from multiple Transmission Reception Points (TRPs), measured by the UE and the measured gNB Rx-Tx measurements and Uplink (UL) Sounding Reference Signal (SRS) Reference Signal Received Power (RSRP) at multiple TRPs of uplink signals transmitted from UE.

UL-TDOA: The UL TDOA positioning method makes use of the UL TDOA (and optionally UL SRS-RSRP) at multiple Reception Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

DL-AoD: The Downlink (DL) Angle of Departure (AoD) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighbouring TPs.

Uplink (UL)-Angle of Arrival (AoA): The UL AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

New Radio (NR)-ECID: NR Enhanced Cell ID (NR E-CID) positioning refers to techniques which use additional UE measurements and/or NR radio resource and other measurements to improve the UE location estimate.

The positioning modes can be categorized in to the below three areas:
UE-Assisted: The UE performs measurements with or without assistance from the network and sends these measurements to the Enhanced Serving Mobile Location Center (E-SMLC) where the position calculation may take place.
UE-Based: The UE performs measurements and calculates its own position with assistance from the network.
Standalone: The UE performs measurements and calculates its own position without network assistance.

### Sidelink Transmissions in NR

Sidelink transmissions over NR are specified for Rel. 16. These are enhancements of the ProSe (Proximity-based Services) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Control Channel (PSCCH).
To achieve a high connection density, congestion control and thus the Quality of Service (QoS) management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH is transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitting the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are two S-PSS sequences and 336 S-SSS sequences forming a total of 672 SSIDs in a cell (for example, as there are 2 different sequence code for SL Primary Synch signal and 336 seq codes for SL Secondary Synch signal: in total (by multiplying these 2) we can get unique 672 codes).
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). SCI is a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for Proximity based services (PROSE) in LTE, NR sidelink transmissions have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a gNB (SR on UL, grant, BSR on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with Cyclic Redundancy Check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the Downlink Control Information (DCI) (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

### Mode 2 Resource Allocation

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequent retransmissions, a transmitter UE may also reserve resources for PSCCH/PSSCH for retransmissions. To further enhance the probability of successful TB decoding in one shot, and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE may select resources for the following transmissions:
1) The PSSCH associated with the PSCCH for initial transmission and blind retransmissions.
2) The PSSCH associated with the PSCCH for retransmissions.

Since each transmitter UE in sidelink transmissions may be required to autonomously select resources for the above transmissions, the question of how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH, depending on the configuration. This information is known only after receiver SCI launched by (all) other UEs. The sensing and selection algorithm is rather complex.

As described in clause 6.3.2.2 in TR 37.985 v 17.1.1, Mode 2 is for UE autonomous resource selection. Its basic structure is of a UE sensing, within a (pre-)configured resource pool, which resources are not in use by other UEs with higher-priority traffic, and choosing an appropriate amount of such resources for its own transmissions. Having selected such resources, the UE can transmit and re-transmit in them a certain number of times, or until a cause of resource reselection is triggered.

The mode 2 sensing procedure can select and then reserve resources for a variety of purposes reflecting that NR Vehicle-to-everything (V2X) introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block, in a manner similar to the LTE-V2X scheme (clause 5.2.2.2). Finally, an initial transmission of a transport block can be performed after sensing and resource selection, but without a reservation.

The first-stage SCIs transmitted by UEs on PSCCH indicate the time-frequency resources in which the UE will transmit a PSSCH. These SCI transmissions are used by sensing UEs to maintain a record of which resources have been reserved by other UEs in the recent past. When a resource selection is triggered (e.g. by traffic arrival or a re-selection trigger), the UE considers a sensing window which starts a (pre-)configured time in the past and finishes shortly before the trigger time. The window can be either 1100 ms or 100 ms wide, with the intention that the 100 ms option is particularly useful for aperiodic traffic, and 1100 ms particularly for periodic traffic. A sensing UE also measures the SL-RSRP in the slots of the sensing window, which implies the level of interference which would be caused and experienced if the sensing UE were to transmit in them. In NR-V2X, SL-RSRP is a (pre-)configurable measurement of either PSSCH-RSRP or PSCCH-RSRP.

The sensing UE then selects resources for its (re-)transmission(s) from within a resource selection window. The window starts shortly after the trigger for (re-)selection of resources, and should not be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE can occupy resources which are reserved by a transmitting UE with sufficiently low SL-RSRP and sufficiently lower-priority traffic.

If the set of resources in the selection window which have not been excluded is less than a certain proportion of the available resources within the window, the SL-RSRP exclusion threshold is relaxed in 3 dB steps. The proportion is set by (pre-)configuration to 20%, 35%, or 50% for each traffic priority. The UE selects an appropriate amount of resources randomly from this non-excluded set. The resources selected are not in general periodic. Up to three resources can be indicated in each SCI transmission, which can each be independently located in time and frequency. When the indicated resources are for semi-persistent transmission of another transport block, the range of supported periodicities is expanded compared to LTE-V2X, in order to cover the broader set of envisioned use cases in NR-V2X.

Shortly before transmitting in a reserved resource, a sensing UE re-evaluates the set of resources from which it can select, to check whether its intended transmission is still suitable, taking account of late-arriving SCIs due, typically, to an aperiodic higher-priority service starting to transmit after the end of the original sensing window. If the reserved resources would not be part of the set for selection at this time (T3), then new resources are selected from the updated resource selection window. The cut-off time T3 is long enough before transmission to allow the UE to perform the calculations relating to resource re-selection.

FIG. 2 illustrates a summary of the sensing and resource (re-)selection procedures in TR 37.985 V 17.1.1.

The timeline of the sensing and resource (re-)selection windows with respect to the time of trigger n, are shown in FIG. 6.3.2.2-2(a) in TR 37.985 V 17.1.1 (FIG. 3 herein), and the effect of the possibility of re-evaluation before first use of the reservation in FIG. 6.3.2.2-2(b) in TR 37.985 V 17.1.1 (FIG. 4 herein).

There are a number of triggers for resource re-selection, several of which are similar to LTE-V2X in Clause 5.2.2.2 in TR 37.985 V 17.1.1. In addition, there is the possibility to configure a resource pool with a pre-emption function designed to help accommodate aperiodic sidelink traffic, so that a UE reselects all the resources it has already reserved in a particular slot if another nearby UE with higher priority indicates it will transmit in any of them, implying a high-priority aperiodic traffic arrival at the other UE, and the SL-RSRP is above the exclusion threshold. The application of pre-emption can apply between all priorities of data traffic, or only when the priority of the pre-empting traffic is higher than a threshold and higher than that of the pre-empted traffic. A UE does not need to consider the possibility of pre-emption later than time T3 before the particular slot containing the reserved resources.

### Inter-UE Coordination for Mode 2 Resource Allocation in 3 gpp Rel-17

The 3 GPP Rel-17 NR sidelink enhancement WID RP-201385 has defined objectives to specify solutions which can enhance NR sidelink for the V2X, public safety and commercial use cases.
Study the feasibility and benefit of the enhancement(s) in mode 2 for enhanced reliability and reduced latency in consideration of both Packet Reception Ratio (PRR) and Packet Inter-reception (PIR) defined in TR37.885 (by RAN #91), and specify the identified solution if deemed feasible and beneficial [RAN1, RAN2]
   Inter-UE coordination with the following until RAN #90.
      A set of resources is determined at UE-A. This set is sent to UE-B in mode 2, and UE-B takes this into account in the resource selection for its own transmission.
   Note: The study scope after RAN #90 is to be decided in RAN #90.
   Note: The solution should be able to operate in-coverage, partial coverage, and out-of-coverage and to address consecutive packet loss in all coverage scenarios.
   Note: RAN2 work will start after [RAN #89].

For the above study objective, an inter-UE coordination mechanism will be studied for enhancements in SL resource allocation Mode 2. With the mechanism, a UE (e.g., UE-A) will be able to signal “A set of resources determined at the UE” to another UE (e.g., UE-B). Another UE can consider the received signaling into its own resource selection procedure. The detailed signaling alternatives are pending to be addressed. The possible signaling alternatives are expected to include at least PC5-RRC signaling, L1 signaling, MAC CE etc.

As described in clause 16.9.8 of TS 38.300 V 17.2.0, the SL UE can support inter-UE coordination (IUC) in Mode 2, whereby a UE-A sends information about resources to UE-B, which UE-B then uses for resource (re)selection. The following schemes of inter-UE coordination are supported:
IUC scheme 1, where the IUC information sent from a UE-A to a UE-B is the preferred or non-preferred resources for UE-B's transmission, and
IUC scheme 2, where the IUC information sent from a UE-A to a UE-B is the presence of expected/potential resource conflict on the resources indicated by UE-B's SCI.

In scheme 1, the transmission of IUC information from UE-A can be triggered by an explicit request from UE-B, or by a condition at UE-A. UE-A determines the set of resources reserved by other UEs or slots where UE-A, when it is the intended receiver of UE-B, does not expect to perform SL reception from UE-B due to half-duplex operation. UE-A uses these resources as the set of non-preferred resources, or excludes these resources to determine a set of preferred resources and sends the preferred/non-preferred resources to UE-B. UE-B's resources for resource (re)selection can be based on both UE-B's sensing results (if available) and the IUC information received from UE-A, or it can be based only on IUC information received from UE-A. For scheme 1, MAC CE and second-stage SCI or MAC CE only can be used to send IUC information. It will be appreciated that transmission of the explicit request and reporting for IUC information in a unicast manner is supported.

In scheme 2, UE-A determines the expected/potential resource conflict within the resources indicated by UE-B's SCI as either resources reserved by other UEs and identified by UE-A as fully/partially overlapping with the resources indicated by UE-B's SCI, or as slots where UE-A is the intended receiver of UE-B and does not expect to perform SL reception on those slots due to half-duplex operation. UE-B uses the conflicting resources to determine the resources to be reselected and exclude the conflicting resources from the reselected resources. For scheme 2, PSFCH is used to send IUC information.

### SL Based Positioning in 3GPP Rel-18

In 3GPP Rel- 18 , SL positioning is being studied. The following study objective has been defined in RP-213561 regarding SL positioning protocol architecture and signaling procedures:

Study of positioning architecture and signalling procedures (e.g. configuration, measurement reporting, etc) to enable sidelink positioning covering both UE based and network based positioning.

The studies need to be performed for the UE (i.e., the target UE which needs to be positioned) in various scenarios with different network coverage, including full coverage, partial coverage and out of coverage, as shown in FIG. 5.

In FIG. 5, the assisting UE (may be also referred to as a reference UE) provides SL measurement assistance to the target UE.

For a target UE out of coverage, there may be different options for the target UE to get positioned. In one option, the target UE may choose to connect to the network via a SL User Equipment to Network (U2N) relay UE. In this case, the network can be involved in the positioning procedure for the target UE. In another option, the target UE may apply UE based positioning by involving an assisting UE. If there is not any assisting UE found in the proximity, the target UE can reach an assisting UE in further range via a User equipment to User Equipment (U2U) relay UE.

The same positioning methods including DL-TDOA, UL-TDOA, and Multi-RTT etc are expected to be also applicable for SL based positioning. For these methods, multiple assisting/reference UEs would be required, as shown in FIG. 6.

For SL based positioning, certain method such as TDOA may require coordination between UEs (i.e., between reference UEs, and/or between each reference UE and the target UE) in order to avoid conflict between resources used by different reference UEs.

In regards to SL positioning, the following terms are defined as:
SL Reference UE: A UE, supporting positioning of target UE, e.g., by transmitting and/or receiving reference signals for positioning, providing positioning-related information, etc., using sidelink. An SL Reference UE is understood as “Anchor UE” in RAN1 TR 38.859. “Reference UE” mentioned in Kis and Solutions of this TR refers to “SL Reference UE”.
Target UE: A UE whose distance, direction and/or position is measured with the support from one or multiple SL Reference Ues using Sidelink in the Ranging based service and Sidelink positioning.
Anchor UE: A UE supporting positioning of target UE, e.g., by transmitting and/or receiving reference signals for positioning, providing positioning-related information, etc., over the SL interface.

### SUMMARY

There currently exist certain challenge(s).

For SL based positioning methods e.g., Time Difference of Arrival (TDOA) and multi-Round Trip Time (RTT), coordination between a reference UE and a target UE, or between reference UEs may be required in order to ensure the positioning accuracy.

However, the existing SL IUC mechanism has the following limitation/issue: A SL IUC message (e.g., in IUC Scheme 1) indicating a preferred resource set is only transmitted in unicast fashion, meaning that a unicast link is required to be established for a UE pair prior to the UE pair being able to exchange IUC messages between each other.

Furthermore, SL positioning utilizing the methods such as TDOA and multi-RTT, would require multiple reference UEs to be involved in the positioning procedure. The existing SL IUC mechanism is only applicable for each UE pair including the target UE and a reference UE. Therefore, multiple SL IUC mechanisms would run in parallel for multiple UE pairs without interaction between each other. In such case, directly reusing existing the SL IUC mechanism for SL positioning would not give sufficiently reliable positioning accuracy due to the requirement of coordination between UEs in the positioning procedure.

It is therefore necessary to study the above issue on IUC for resource reservation and develop solutions on how to enhance the existing SL IUC for SL positioning.

Certain aspects of the disclosure and their embodiments may provide solutions to these or other challenges.

Embodiments described herein provide various solutions relating to SL based positioning. In particular, embodiments described herein describe IUC mechanisms for resource reservation to coordinate reference UEs and/or the target UE for more accurate SL positioning.

In order to improve inter-UE coordination between UEs for SL positioning purposes, the following methods is proposed:

One of the UE (e.g. a controlling UE) may perform a coordination role for other UEs involved in the positioning procedure. The controlling UE may comprise the target UE, a reference UE or in some embodiments another UE. This controlling UE transmits one or more IUC messages to each of a plurality of reference UEs. The one or more IUC messages comprising at least one of the following:
A set of preferred resources for transmissions (e.g. comprising positioning reference signals and positioning related signaling and/or assistance information);
a set of non-preferred resources for transmissions (e.g. comprising positioning reference signals and positioning related signaling and/or assistance information);
a duration for ranging and/or positioning;
QoS requirements for ranging and/or positioning;
ranging and/or positioning capabilities in terms of bandwidth, processing time.
one or more indicators indicating resource conflict or interference. The one or more indicators may cover one or multiple resources. The one or more indicators may cover one or multiple resource regions (in time domain and/or frequency domain).

The controlling UE performs the coordination role for other UEs involved in the positioning procedure. The controlling UE may perform coordination actions to determine the one or more IUC messages. The coordination actions may comprise at least one of the following e.g.:
Avoid preferred resources to be overlapped between reference UEs if it is required;
Ensure preferred resources to be overlapped (partially or fully) between reference UEs if it is required;
Ensure preferred resources to be not overlapped in frequency domain, however, overlapped in time domain between reference UEs if it is required;
Ensure preferred resources to be located closely in frequency domain and/or time domain between reference UEs if it is required;
Ensure transmissions from different reference UEs to be able combined together for processing if it is required;
Ensure transmissions from different reference UEs to be able separated and not interfering between each other if it is required.

UEs which are in proximity may be discovered and form a group. Once the group has been made and the UEs within the group have acknowledged that they are part of the group, they may then participate in a sidelink positioning procedure involving synchronized transmission/reception of SL-PRS. In this example, one of the UEs is given the role of controlling UE, and the controlling UE may bulk reserve (reserve resources on behalf of other UEs) the SL resource for the group using IUC.

The controlling UE may comprise the target UE, a reference UE or any UE that has the capability to perform the bulk reservation.

For any one of the above, each IUC message may be transmitted in SL unicast, SL groupcast or SL broadcast fashion.

According to some embodiments there is provided a method performed by a first controlling user equipment, UE, for enabling performance of sidelink, SL, positioning of a target UE using a plurality of reference UEs. The method comprises determining one or more inter UE coordination, IUC, messages relating to resource reservation for the plurality of reference UEs; and transmitting the one or more IUC messages to the plurality of reference UEs.

According to some embodiments there is provided a method in a network node for enabling performance of sidelink, SL, positioning of a target user equipment, UE, using a plurality of reference UEs. The method comprises configuring one or more SL group positioning resource pools that can only be reserved when two or more reference UEs are being used for SL positioning.

According to some embodiments there is provided a first controlling user equipment, UE, for enabling performance of sidelink, SL, positioning of a target UE using a plurality of reference UEs. The first controlling UE comprises processing circuitry and memory, characterized in that that the memory containing instructions executable by the processing circuitry whereby the first user equipment is operable to: determine one or more inter UE coordination message relating to resource reservation for the plurality of reference UEs; and transmit the one or more IUC messages to the plurality of reference UEs.

According to some embodiments there is provided a network node for enabling performance of sidelink, SL, positioning of a target user equipment, UE, using a plurality of reference UEs. The network node comprises processing circuitry and memory, characterized in that the memory containing instructions executable by the processing circuitry whereby the network node is operable to: configure one or more SL group positioning resource pools that can only be reserved when two or more reference UEs are being used for SL positioning.

According to some embodiments there is provided a first controlling user equipment, UE, (1100) for enabling performance of sidelink, SL, positioning of a target UE using a plurality of reference UEs. The first controlling UE is operable to: determine one or more inter-UE coordination message relating to resource reservation for the plurality of reference UEs; and transmit the one or more IUC messages to the plurality of reference UEs.

According to some embodiments there is provided network node for enabling performance of sidelink, SL, positioning of a target user equipment, UE, using a plurality of reference UEs, wherein the network node operable to: configure one or more SL group positioning resource pools that can only be reserved when two or more reference UEs are being used for SL positioning.

According to some embodiments there is provided a computer program, comprising instructions which, when executed on at least one processor, cause the at least one processor to carry out any of the methods described above.

According to some embodiments there is provided a carrier containing the computer program as described above, wherein the carrier comprises one of an electronic signal, optical signal, radio signal or computer readable storage medium.

According to some embodiments there is provided a computer-readable medium comprising instructions that, when executed on at least one processor, cause the at least one processor to perform any of the methods described above.

According to some embodiments there is provided a computer program product comprising non transitory computer readable media having stored thereon a computer program as described above.

Certain embodiments may provide one or more of the following technical advantage(s). With the proposed coordination mechanisms, positioning signals are transmitted by references UEs towards the same target UE in a coordinated fashion to avoid resource conflict and interference. Thus, positioning accuracy can be ensured for the target UE. With the proposed coordination mechanisms, positioning signals are transmitted by the target UE towards the reference UEs in a coordinated fashion to avoid resource conflict. Thus, positioning accuracy can be ensured for the target UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 is a schematic diagram illustrating NG-RAN Rel-15 LCS protocols ; ;

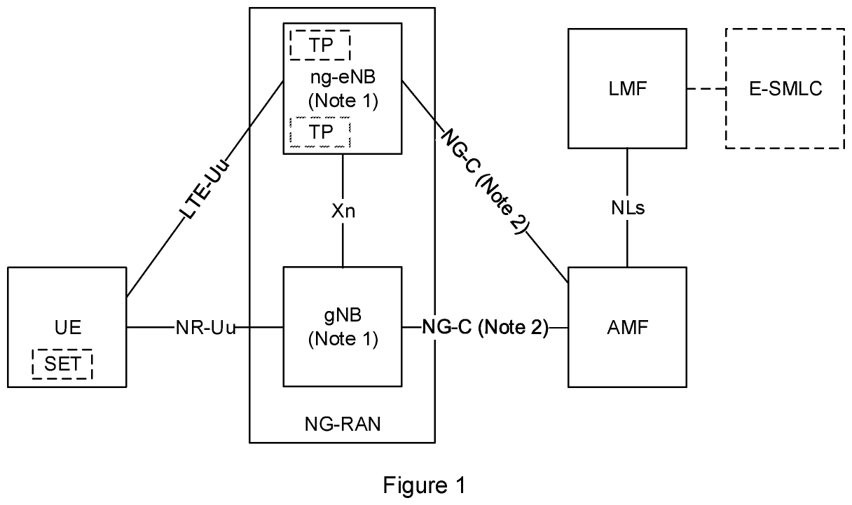

FIG. 2 is a flow chart illustrating a sensing and resource (re-)selection procedure;

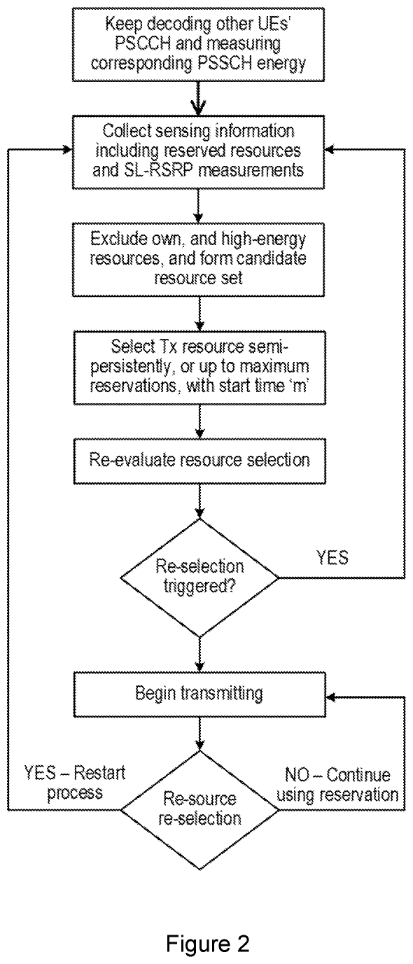

FIG. 3 is a timeline of a sensing and resource (re-)selection procedure;

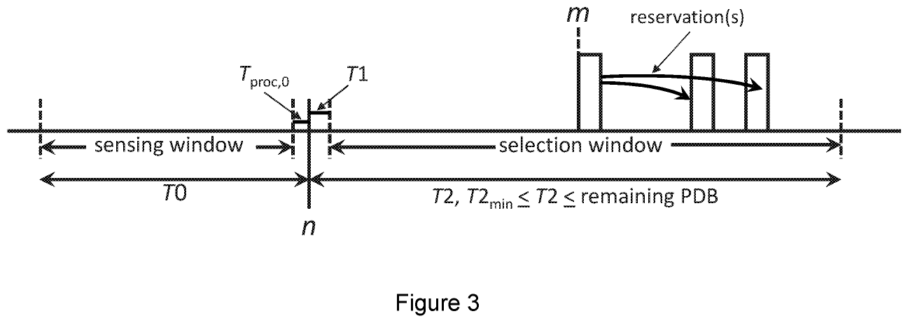

FIG. 4 is a timeline of a sensing and resource (re-)selection procedure;

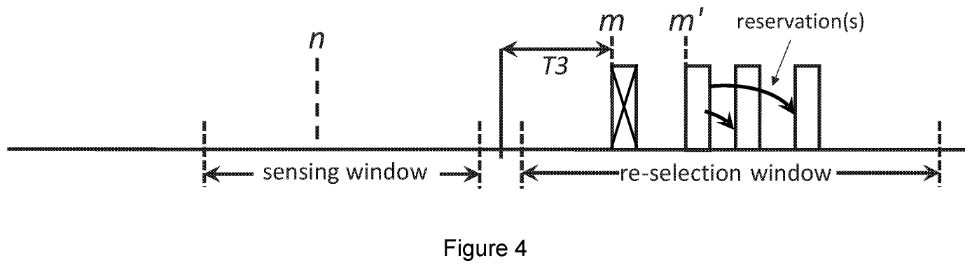

FIG. 5: is a schematic diagram illustrating SL positioning for UEs in different coverage scenarios;

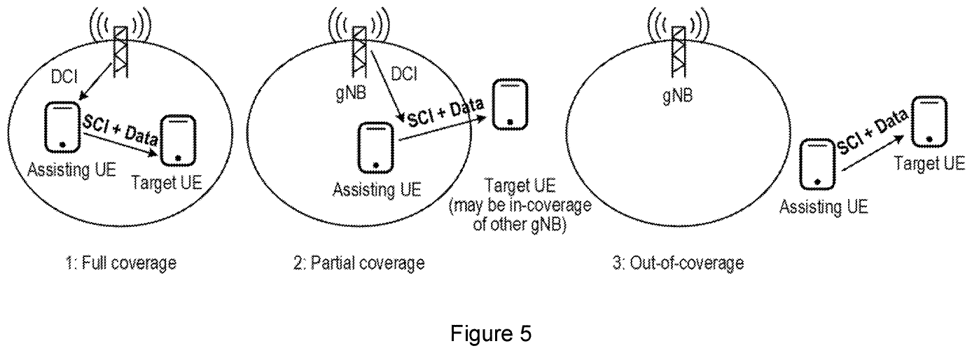

FIG. 6 is a schematic diagram illustrating SL positioning and ranging;

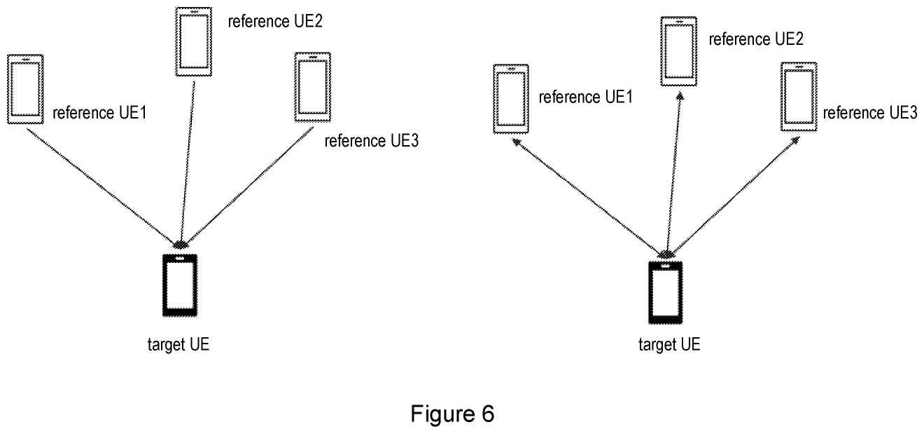

FIG. 7 is a flow chart illustrating a method in accordance with some embodiments;

FIG. 8 is a signaling diagram illustrating an example procedure to achieve tight synchronization between UEs for SL based positioning;

FIG. 9 is a flow chart illustrating a method in accordance with some embodiments;

FIG. 10 shows an example of a communication system in accordance with some embodiments;

FIG. 11 shows a UE in accordance with some embodiments;

FIG. 12 shows a network node in accordance with some embodiment

FIG. 13 is a block diagram of a host;

FIG. 14 is a block diagram illustrating a virtualization environment in which functions implemented by some embodiments may be virtualized; and

FIG. 15 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

The embodiments are described herein in the context of New Radio NR, i.e., a target UE and reference/assisting UE are deployed in a same or different NR cell. The link between a target UE and an assisting UE may be based on LTE sidelink, NR sidelink or any other short-range communication technology such as Wifi is equally applicable. The Uu connection between the target UE or the reference UE and base station may be LTE Uu or NR Uu.

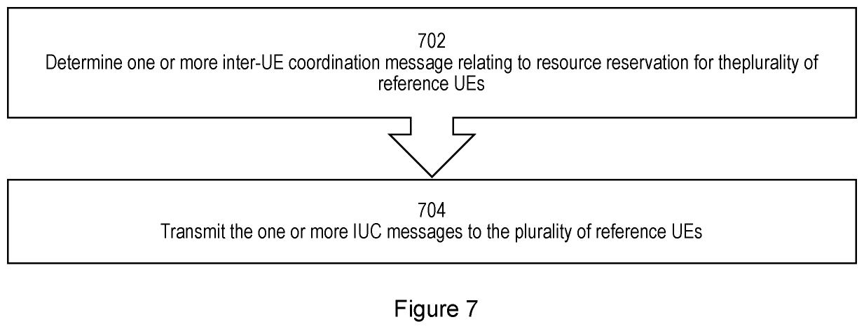

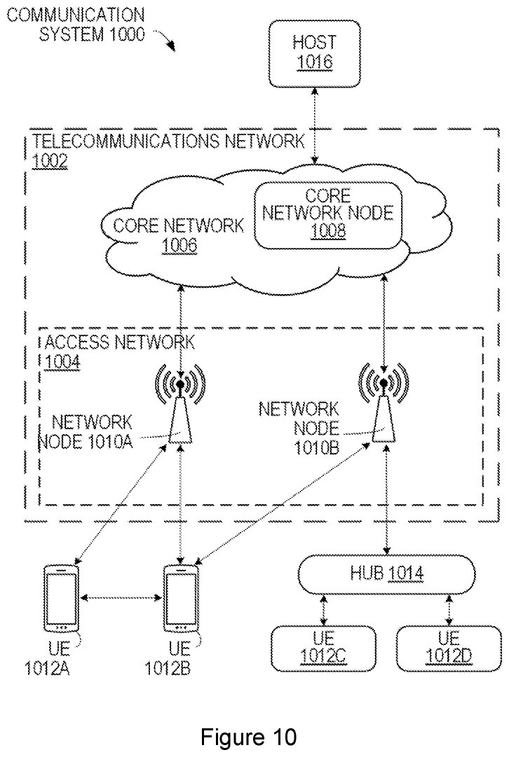

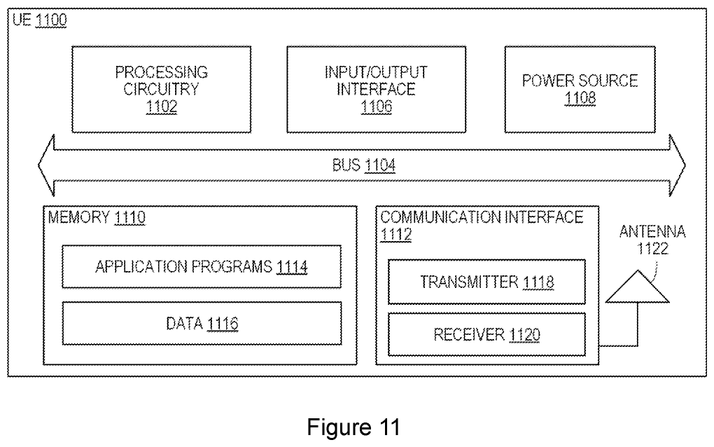

FIG. 7 depicts a method in accordance with particular embodiments. The method of FIG. 7 may be performed by a UE or wireless device (e.g. the UE 1012 or UE 1100 as described later with reference to FIGS. 10 and 11 respectively). The method may be performed by a first controlling UE for enabling performance of sidelink, SL, positioning of a target UE using a plurality of reference UEs. The method begins at step 702 with determining one or more inter-UE coordination messages relating to resource reservation for the plurality of reference UEs. In step 704 the method comprises transmitting the one or more IUC messages to the plurality of reference UEs.

Each IUC message may comprise one of the following:
A set of preferred resources for transmissions (including positioning reference signals and positioning related signaling and/or assistance information);
A set of non-preferred resources for transmissions (including positioning reference signals and positioning related signaling and/or assistance information);
Duration for ranging/positioning;
QoS requirements for ranging/positioning;
Ranging/positioning capabilities in terms of bandwidth, processing time;
Indicators indicating resource conflict or interference. The indicators may cover one or multiple resources and/or one or multiple resource regions (in time domain and/or frequency domain).

In other words, the one or more IUC messages comprise an indication of one or more of the following: a duration for ranging and/or positioning; one or more Quality of Service, QoS, requirements for ranging and/or positioning; one or more ranging and/or positioning capabilities; and one or more indicators indicating resource conflict or interference.

For example, the method of Figure VV may further comprise determining preferred resources, non preferred resources, and/or resource conflict or interference for each of the plurality of reference UEs for use in the SL positioning; and indicating, in the one or more IUC messages, the preferred resources, non preferred resources and/or resource conflict or interference to each of the plurality of reference UEs.

The step of indicating the preferred resources, non preferred resources and/or resource conflict or interference may comprise one or more of: identifying the preferred resources in the one or more IUC messages; identifying non-preferred resources for transmission in the one or more IUC messages; and identifying resource conflict in the one or more IUC messages.

The controlling UE coordinates (e.g. by performing coordination actions) the UEs involved in the SL positioning procedure via the one or more IUC messages. The coordination actions may comprise one or more of the following:
Avoid preferred resources to be overlapped between reference UEs if it is required;
Ensure preferred resources to be overlapped (partially or fully) between reference UEs if it is required;
Ensure preferred resources to be not overlapped in frequency domain, however, overlapped in time domain between reference Ues if it is required;
Ensure preferred resources to be located closely in frequency domain and/or time domain between reference Ues if it is required. For example, preferred resources may be considered to be located “closely” if they are within X PRBs in frequency domain, Y slots in time domain, where X and Y are integer values.
Ensure transmissions from different reference UEs to be able combined together for processing if it is required;
Ensure transmissions from different reference UEs to be able separated and not interfering between each other if it is required.

In other words, the step of determining preferred resources, non preferred resources, and/or resource conflict or interference for each of the plurality of reference UEs may comprise ensuring that one or more of the following conditions are met:
the preferred resources for the plurality of reference UEs do not overlap;
the preferred resources for the plurality of reference UEs overlap or partially overlap;
the preferred resources for the plurality of reference UEs do not overlap in a frequency domain but do overlap in a time domain;
the preferred resources for the plurality of reference UEs are located closely in a time domain and/or frequency domain;
the preferred resources for the plurality of reference UEs are allocated such that transmissions from the plurality of reference UEs can be combined together for processing; and
the preferred resources for the plurality of reference UEs are allocated such that transmissions from different reference UEs can be separated and do not interfere with each other.

The controlling UE may transmit the one or more IUC messages in one of the following ways:
Option 1: unicast IUC messages transmitted to each reference UE respectively.
Option 2: broadcast IUC messages to reference UEs in a broadcast fashion.
Option 3: provide IUC messages to reference UEs in a groupcast fashion

For options 2 and 3:
The IUC messages may be addressed to a specific Layer 2, L2, identification, ID, which may indicate that the associated IUC message is for coordination purpose (e.g. for broadcast coordination or for coordination of the group).
Each IUC message may comprise resources or information for each reference UE respectively. In this case, the ID of each reference UE may be included in the IUC message. A IUC message may comprise resources or information for more than one reference UEs.

For option 3, the target UE and the reference UEs may be included in the same group for positioning purposes. A group ID may be assigned to UEs accordingly.

In other words, the step of transmitting the one or more IUC messages (704) may comprise: transmitting a unicast IUC to each reference UE respectively; broadcasting an inter-UE coordination, IUC, message; or transmitting an IUC message to all UEs in a group comprising the plurality of reference UEs and the target UE. For example, the IUC message may comprise an identification of each of the plurality of reference UEs associated with the indication of the preferred resources, non preferred resources and/or resource conflict or interference.

In some examples, an IUC (e.g. as described above) may be transmitted by a controlling node to another controlling node (e.g. as described above) in a different group. For example, the IUC may further comprise one or more indicators indicating reserved bulk resources, bulk resource conflict or bulk interference. The indicators may cover one or multiple bulk resources. The indicators may cover one or multiple bulk resource regions (in time domain and/or frequency domain).

In case a IUC message is provided to reference UEs in broadcast or groupcast fashion, the IUC message may comprise resources or information for each reference UE respectively. In this case, the ID of each reference UE is also included in the IUC message. The IUC message may comprise resource or information for multiple reference UEs. For example, the broadcast or groupcast IUC may comprise an identification of each of the plurality of reference UEs associated with the indication of the preferred resources, non-preferred resources and/or resource conflict or interference.

It will be appreciated that for performance of SL positioning of a target UE the following may occur: A target UE may have selected one or more reference/assisting UEs for a positioning request. The one or more reference UEs may be required to perform SL transmissions towards the target UE in a coordinated fashion so that the target UE can perform measurements accordingly.

In some examples, the controlling UE comprises the target UE. The target UE may perform sensing towards each reference UE. Based on the sensing results, the target UE provides IUC messages to reference UEs as described above. For example, the target UE may perform sensing of the plurality of reference UEs and may then perform the step of determining the preferred resources, non preferred resources and/or resource conflict or interference based on the sensing.

In some examples, the controlling UE comprises another UE which is different from the target UE. For example, the controlling UE may comprise a reference UE or another UE that is not the target UE or a reference UE. In this case, the controlling UE may obtain sensing results towards the reference UEs and/or the target UE via one of more of the following options:
Option 1: the controlling UE performs sensing operation by itself;
Option 2: the target UE performs sensing operation and provides sensing results to the controlling UE;
Option 3: one or multiple reference UEs perform sensing operation and provide sensing results to the controlling UE.

For example, the controlling UE may perform a sensing operation, wherein the sensing operation comprises one of: performing sensing of the plurality of reference UEs; receiving sensing results from the target UE; and receiving sensing results from the plurality of reference UEs.

The controlling UE may then perform the step of determining the preferred resources, non preferred resources and/or resource conflict or interference based on the sensing operation.

In some examples, the controlling UE comprises a reference UE. In this example, the controlling UE may perform coordination between the reference UEs. One of the reference UEs may be elected as a controlling reference UE to take care of the coordination role. The coordination actions performed by the controlling UE may be same as the coordination actions described above. Each reference UE may then perform sensing towards the target UE. Based on the sensing results, each reference UE may then provide IUC messages to the target UE respectively.

The target UE may use the same resources for transmissions towards the reference UEs. In this case, the transmissions may be performed in a groupcast or broadcast fashion.

The target UE may use different resources for transmissions towards different reference UE respectively. In this case, the transmissions may be performed in a unicast fashion.

In some examples, another UE (i.e., the controlling UE) different from the reference UEs and the target UE may perform the coordination role. In this case, the controlling UE may provide IUC messages to the references and/or the target UE. In this embodiment, the controlling UE may perform sensing operation by itself or collect sensing results from the references UEs and/or the target UEs. Based on the sensing results, the controlling UE generates the IUC messages accordingly.

### Bulk Reservation of Resources

Performing positioning procedure such as TDOA or Multi-RTT requires involvement of multiple users (UEs). A group of UEs is involved. Using discovery procedures, UEs which are in proximity are discovered and can be added to form a group. Once the group has been performed and the UEs have acknowledged that they are part of the group, they may participate in a positioning procedure involving synchronized transmission/reception of SL-PRS. In other words, the SL positioning may require synchronized transmission by the plurality of reference UEs and/or reception at the target UE of SL Positioning Reference Signals.

In this example, the step of determining preferred resources, non preferred resources, and/or resource conflict or interference for each of the plurality of reference UEs for use in the SL positioning comprises determining the same preferred resources for each of the plurality of reference UEs. In this example, the step of determining preferred resources, non preferred resources, and/or resource conflict or interference for each of the plurality of reference UEs for use in the SL positioning comprises determining the same preferred resources for each of the plurality of reference UEs. For example, the step of determining the same preferred resources may comprise: determining an amount of the preferred resources based on: a number of UEs in a group comprising the target UE and the plurality of reference UEs; quality of service, QoS, requirements of positioning and/or ranging duration of positioning and/or ranging; and required positioning and/or ranging measurements and/or methods.

In this example, the method of FIG. 7 may further comprise receiving an indication of one or more SL group-based positioning resource pools from a network node. For example, the method of FIG. 7 may then comprise sensing the plurality of reference UEs on the SL group-based positioning resource pool.

For example, responsive to determining that one or more resources in the SL group-based resource pools are currently being used, the method of FIG. 7 may then comprise determining, based on a maximum number of resources than can be reserved in the SL group-based resource pools, the preferred resources as one or more resources that are not being used.

In this example, the method of FIG. 7 may further comprise transmitting an indication of the preferred resources, non preferred resources and/or resource conflict or interference to a second controlling UE.

In this example, the controlling UE may comprise the target UE or one of the plurality of reference UEs.

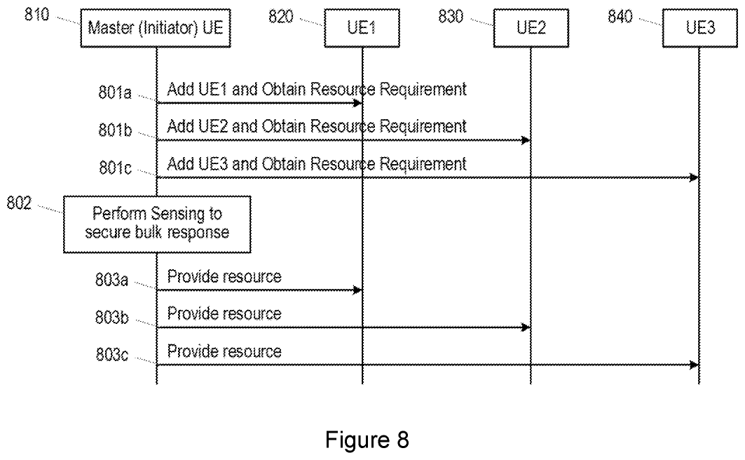

FIG. 8 is a signaling diagram illustrating a positioning procedure.

In the procedure of FIG. 8, one of the UEs (810) is given the role to bulk reserve (reserve the resource on behalf of other UEs) the SL resource for the group (810 to 840) using IUC messages (e.g. steps 801a to 801c and/or 803a to 803c as shown in FIG. 8). This UE may be referred to as the controlling UE. The controlling UE may perform the method as described with reference to FIG. 7. The role may be fixed; i.e initiator UE can be the UE who performs or one of the UEs which has the capability to perform the bulk reservation (e.g., the controlling UE may comprise a target UE or one of the plurality of reference UEs).

In steps 801a to 801c the controlling UE adds the other UEs to the group and obtains their resource requirements.

In step 802 the controlling UE performs sensing to secure a bulk resource.

In step 803a to 803c the controlling UE provides the resource reservations to the other UEs in the group.

The (amount of) bulk resource reservation may be based upon one or more of:
A number of UEs in the group;
QoS requirements of Positioning/Ranging;
A duration of Ranging/Positioning;
Required Ranging/Positioning measurements/methods such as TDOA, multi-RTT etc.

Once the bulk reservation is decided to be performed, the network, NW, may configure/preconfigure one or more SL positioning resource pools in a way that certain resource pools can be reserved only when more than two UEs are involved for positioning; i. e for the case of multi-RTT or TDOA. The group resources which can be reserved can be indicated to UEs via dedicated signaling or via System information.

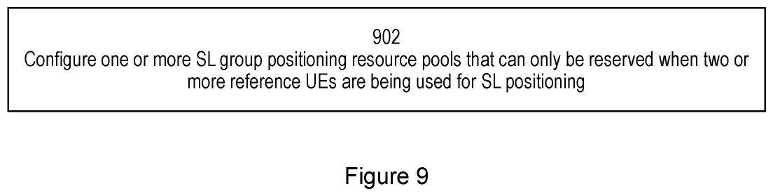

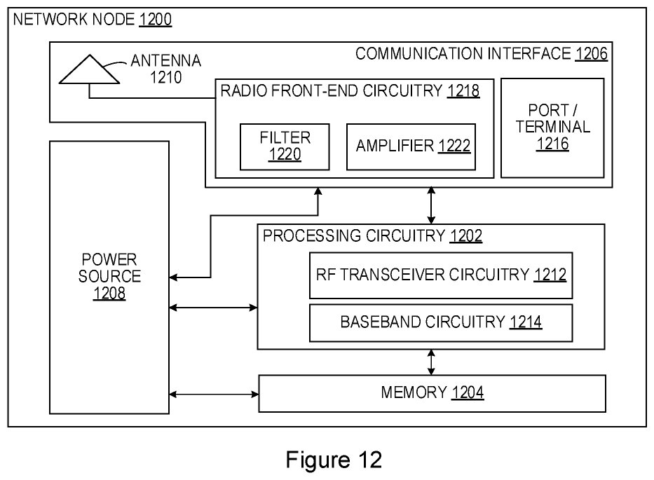

FIG. 9 depicts a method in accordance with particular embodiments. The method of FIG. 9 may be performed by a network node (e.g. the network node 1010 or network node 1200 as described later with reference to FIGS. 10 and 12 respectively). The method may be performed by a network node for enabling performance of sidelink, SL, positioning of a target user equipment, UE, using a plurality of reference UEs. The method begins at step 902 with configuring one or more SL group positioning resource pools that can only be reserved when two or more reference UEs are being used for SL positioning. In some embodiments, the method of FIG. 9 may further comprise indicating the SL group positioning resource pools to the target UE and/or the reference UEs utilizing dedicated signalling or system information.

### Bulk Resource Reservation Based Sensing

When a UE has to reserve bulk of resources; it may perform sensing only in the part of the resource pool which is reserved for group (series of unicast or groupcast or broadcast involving more than two users) based positioning.

If group-based resource reservation is done; a minimum and maximum amount of resources that can be reserved may also be defined. Therefore, if a UE senses that certain part of resource is currently being used; it may estimate what is the maximum amount (periodical occurrence) of resources that could be blocked so that it can reserve resources beyond that.

Furthermore, there may be IUC between two UEs which have bulk resource capabilities such that they could be part of different groups and they coordinate/share what resources have been already reserved by them.

For any one of the above embodiments, any signaling between any two UEs (i.e., reference UE, target UE or controlling UE) may comprise one or more of the following:
A discovery message;
PC5-S signaling;
PC5-RRC signaling;
A MAC CE;
A Control PDU of a protocol layer (e.g., SDAP, PDCP, RLC or an adaptation layer in case of SL relay); and
L1 signaling on physical channels (e.g., PSSCH, PSCCH, PSFCH etc).

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 10, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, a content source and analytics node, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub-that is, a hub whose primary function is to route communications to/from the UEs from/to the network node 1010b. In other embodiments, the hub 1014 may be a non-dedicated hub-that is, a device which is capable of operating to route communications between the UEs and network node 1010b, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs). The processing circuitry 1102 may be operable to provide, either alone or in conjunction with other UE 1100 components, such as the memory 1110, UE 1100 functionality. For example, the processing circuitry 1102 may be configured to cause the UE 1102 to perform the methods as described with reference to FIG. 7.

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In some embodiments, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes processing circuitry 1202, a memory 1204, a communication interface 1206, and a power source 1208, and/or any other component, or any combination thereof. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment. For example, the processing circuitry 1202 may be configured to cause the network node 1102 to perform the methods as described with reference to FIG. 9.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

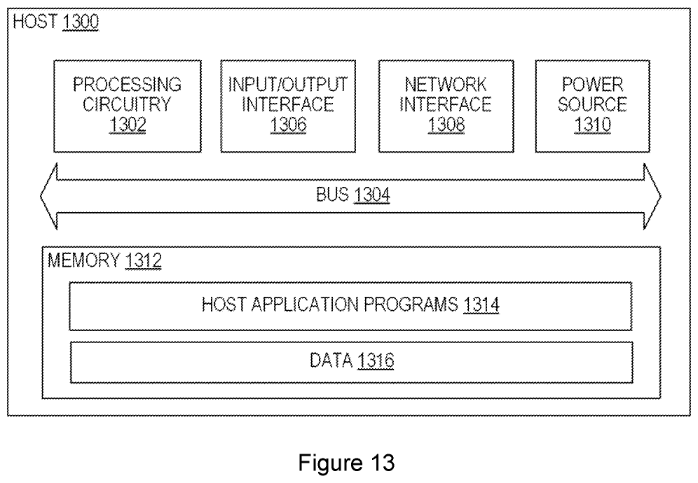

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

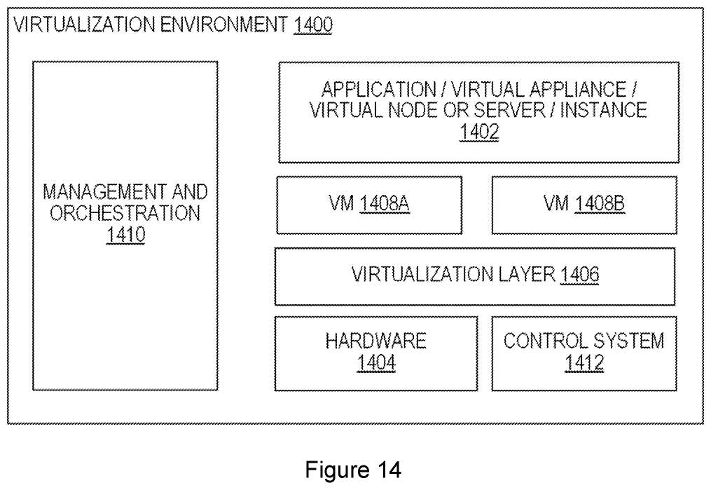

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

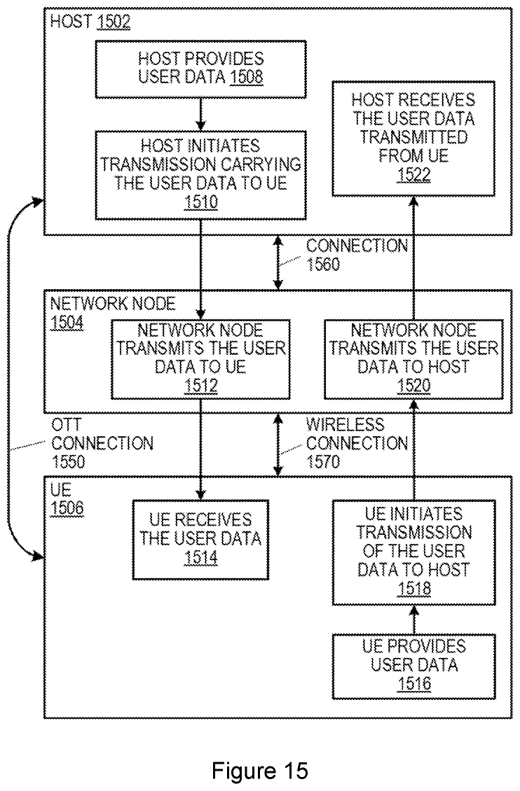

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may reduce resource conflict of positioning signals and thereby provide benefits such as reduced signal interference and improved positioning accuracy.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group A Embodiments

1. A method performed by a first controlling user equipment, UE, for enabling performance of sidelink, SL, positioning of a target UE using a plurality of reference UEs, the method comprising:
   determining one or more inter-UE coordination message relating to resource reservation for the plurality of reference UEs; and
   transmitting the one or more IUC messages to the plurality of reference UEs.
2. The method of claim 1 further comprising:
   determining preferred resources, non preferred resources, and/or resource conflict or interference for each of the plurality of reference UEs for use in the SL positioning; and
   indicating, in the one or more IUC messages, the preferred resources, non preferred resources and/or resource conflict or interference to each of the plurality of reference UEs.
3. The method of embodiment 2 wherein the step of determining comprises ensuring one or more of the following conditions are met:
   the preferred resources for the plurality of reference UEs do not overlap;
   the preferred resources for the plurality of reference UEs overlap or partially overlap;
   the preferred resources for the plurality of reference UEs do not overlap in a frequency domain but do overlap in a time domain;
   the preferred resources for the plurality of reference UEs are located closely in a time domain and/or frequency domain;
   the preferred resources for the plurality of reference UEs are allocated such that transmissions from the plurality of reference UEs can be combined together for processing; and
   the preferred resources for the plurality of reference UEs are allocated such that transmissions from different reference UEs can be separated and do not interfere with each other.
4. The method of any one of embodiments 2 or 3 wherein the step of indicating the preferred resources, non preferred resources and/or resource conflict or interference comprises one or more of:
   identifying the preferred resources in the one or more IUC messages;
   identifying non-preferred resources for transmission in the one or more IUC messages; and
   identifying resource conflict in the one or more IUC messages.
5. The method of any previous embodiment wherein the one or more IUC messages comprise an indication of one or more of the following:
   a duration for ranging and/or positioning;
   one or more Quality of Service, QoS, requirements for ranging and/or positioning;
   one or more ranging and/or positioning capabilities; and
   one or more indicators indicating resource conflict or interference.
6. The method of any previous embodiment wherein the step of transmitting the one or more IUC messages comprises:
   transmitting a unicast IUC to each reference UE respectively.
7. The method of any one of embodiments 1 to 5 wherein the transmitting the one or more IUC messages comprises:
   broadcasting an inter-UE coordination, IUC, message, or transmitting an IUC message to all UEs in a group comprising the plurality of reference UEs and the target UE.
8. The method of embodiment 7 wherein the IUC message comprises:
   an identification of each of the plurality of reference UEs associated with the indication of the preferred resources, non preferred resources and/or resource conflict or interference.
9. The method of any previous embodiment wherein the controlling UE comprises the target UE.
10. The method of embodiment 9 when dependent on embodiment 2 wherein the target UE performs sensing of the plurality of reference UEs and performs the step of determining the preferred resources, non preferred resources and/or resource conflict or interference based on the sensing.
11. The method of any one of embodiments 1 to 8 wherein the controlling UE comprises one of the plurality of reference UEs or a UE that is not the target UE or one of the plurality of reference UE.
12. The method of embodiment 11 wherein the controlling UE performs a sensing operation, wherein the sensing operation comprises one of:
   performing sensing of the plurality of reference UEs;
   receiving sensing results from the target UE; and
   receiving sensing results from the plurality of reference UEs.
13. The method of embodiment 12 when dependent on embodiment 2 wherein the controlling UE performs the step of determining the preferred resources, non preferred resources and/or resource conflict or interference based on the sensing operation.
14. A method as in embodiment 2, wherein the SL positioning requires synchronized transmission by the plurality of reference UEs and/or reception at the target UE of SL Positioning Reference Signals, wherein the step of determining preferred resources, non preferred resources, and/or resource conflict or interference for each of the plurality of reference UEs for use in the SL positioning comprises:
   determining the same preferred resources for each of the plurality of reference UEs.
15. The method of embodiment 14 wherein the step of determining the same preferred resources comprises:
   determining an amount of the preferred resources based on:
      a number of UEs in a group comprising the target UE and the plurality of reference UEs;
      quality of service, QoS, requirements of positioning and/or ranging duration of positioning and/or ranging; and
      required positioning and/or ranging measurements and/or methods.
16. The method of embodiment 14 or 15 further comprising:
   receiving an indication of one or more SL group-based positioning resource pools from a network node.
17. The method of embodiment 16 further comprising:
   sensing the plurality of reference UEs on the SL group-based positioning resource pools.
18. The method of embodiment 17 further comprising:
   responsive to determining that one or more resources in the SL group-based resource pools are currently being used, determining, based on a maximum number of resources than can be reserved in the SL group-based resource pools, the preferred resources as one or more resources that are not being used.
19. The method of any one of embodiments 14 to 18 further comprising:
   transmitting an indication of the preferred resources, non preferred resources and/or resource conflict or interference to a second controlling UE.
20. The method of embodiment 14 to 19 wherein the controlling UE comprises the target UE or one of the plurality of reference UEs.
19. The method of any of the previous embodiments, further comprising:
   providing user data; and
   forwarding the user data to a host via the transmission to the network node.

### Group B Embodiments

20. A method in a network node for enabling performance of sidelink, SL, positioning of a target user equipment, UE, using a plurality of reference UEs, the method comprising:
   configuring one or more SL group positioning resource pools that can only be reserved when two or more reference UEs are being used for SL positioning.
21. The method of embodiment 21 further comprising indicating the SL group positioning resource pools to the target UE and/or the reference UEs utilizing dedicated signalling or system information.

### Group C Embodiments

22. A user equipment for enabling performance of sidelink, SL, positioning of a target UE using a plurality of reference UEs, comprising:
   processing circuitry configured to cause the user equipment to perform any of the steps of any of the Group A embodiments; and
   power supply circuitry configured to supply power to the processing circuitry.
23. A network node for enabling performance of sidelink, SL, positioning of a target user equipment, UE, using a plurality of reference UEs, the network node comprising:
   processing circuitry configured to cause the network node to perform any of the steps of any of the Group B embodiments;
   power supply circuitry configured to supply power to the processing circuitry.
24. A user equipment (UE) for enabling performance of sidelink, SL, positioning of a target UE using a plurality of reference UEs, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
25. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
26. The host of the previous embodiment, wherein the cellular network further includes a network node configured to communicate with the UE to transmit the user data to the UE from the host.
27. The host of the previous 2 embodiments, wherein:
   the processing circuitry of the host is configured to execute a host application, thereby providing the user data; and
   the host application is configured to interact with a client application executing on the UE, the client application being associated with the host application.
28. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
29. The method of the previous embodiment, further comprising:
   at the host, executing a host application associated with a client application executing on the UE to receive the user data from the UE.
30. The method of the previous embodiment, further comprising:
   at the host, transmitting input data to the client application executing on the UE, the input data being provided by executing the host application,
   wherein the user data is provided by the client application in response to the input data from the host application.
31. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
32. The host of the previous embodiment, wherein the cellular network further includes a network node configured to communicate with the UE to transmit the user data from the UE to the host.
33. The host of the previous 2 embodiments, wherein:
   the processing circuitry of the host is configured to execute a host application, thereby providing the user data; and
   the host application is configured to interact with a client application executing on the UE, the client application being associated with the host application.
34. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
35. The method of the previous embodiment, further comprising:
   at the host, executing a host application associated with a client application executing on the UE to receive the user data from the UE.
36. The method of the previous embodiment, further comprising:
   at the host, transmitting input data to the client application executing on the UE, the input data being provided by executing the host application,
   wherein the user data is provided by the client application in response to the input data from the host application.
37. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
38. The host of the previous embodiment, wherein:
   the processing circuitry of the host is configured to execute a host application that provides the user data; and
   the UE comprises processing circuitry configured to execute a client application associated with the host application to receive the transmission of user data from the host.
39. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
40. The method of the previous embodiment, further comprising, at the network node, transmitting the user data provided by the host for the UE.
41. The method of any of the previous 2 embodiments, wherein the user data is provided at the host by executing a host application that interacts with a client application executing on the UE, the client application being associated with the host application.
42. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
43. The communication system of the previous embodiment, further comprising:
   the network node; and/or
   the user equipment.
44. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
45. The host of the previous embodiment, wherein:
   the processing circuitry of the host is configured to execute a host application, thereby providing the user data; and
   the host application is configured to interact with a client application executing on the UE, the client application being associated with the host application.
46. The host of the any of the previous 2 embodiments, wherein the initiating receipt of the user data comprises requesting the user data.
47. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
48. The method of the previous embodiment, further comprising at the network node, transmitting the received user data to the host.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
SI System Information
NAS Non-Access Stratum
LMF Location Management Function
AMF Access Management Function
1x RTT CDMA2000 1x Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1-35. (canceled)

36. A method performed by a first controlling user equipment (UE) for enabling performance of sidelink (SL) positioning of a target UE using a plurality of reference UEs, the method comprising:
determining one or more inter-UE coordination (IUC) messages relating to resource reservation for the plurality of reference UEs; and
transmitting the one or more IUC messages to the plurality of reference UEs.

37. The method of claim 36, further comprising:
determining preferred resources, non preferred resources, and/or resource conflict or interference for each of the plurality of reference UEs for use in the SL positioning; and
indicating, in the one or more IUC messages, the preferred resources, non preferred resources and/or resource conflict or interference to each of the plurality of reference UEs.

38. The method of claim 37. wherein the step of determining preferred resources, non preferred resources, and/or resource conflict or interference comprises ensuring one or more of the following conditions are met:
the preferred resources for the plurality of reference UEs do not overlap;
the preferred resources for the plurality of reference UEs overlap or partially overlap;
the preferred resources for the plurality of reference UEs do not overlap in a frequency domain but do overlap in a time domain;
the preferred resources for the plurality of reference UEs are located closely in a time domain and/or frequency domain;
the preferred resources for the plurality of reference UEs are allocated such that transmissions from the plurality of reference UEs can be combined together for processing; and
the preferred resources for the plurality of reference UEs are allocated such that transmissions from different reference UEs can be separated and do not interfere with each other.

39. The method of claim 37, wherein the step of indicating the preferred resources, non preferred resources and/or resource conflict or interference comprises one or more of:
identifying the preferred resources in the one or more IUC messages;
identifying non-preferred resources for transmission in the one or more IUC messages; and
identifying resource conflict in the one or more IUC messages.

40. The method of claim 36, wherein the one or more IUC messages comprise an indication of one or more of the following:
a duration for ranging and/or positioning;
one or more Quality of Service (QoS) requirements for ranging and/or positioning;
one or more ranging and/or positioning capabilities; and
one or more indicators indicating resource conflict or interference.

41. The method of claim 36, wherein the step of transmitting the one or more IUC messages comprises:
transmitting a unicast IUC to each reference UE respectively.

42. The method of claim 36, wherein the transmitting the one or more IUC messages comprises:
broadcasting an inter-UE coordination (IUC) message, or transmitting an IUC message to all UEs in a group comprising the plurality of reference UEs and the target UE.

43. The method of claim 42, wherein the IUC message comprises:
an identification of each of the plurality of reference UEs associated with the indication of the preferred resources, non preferred resources and/or resource conflict or interference.

44. The method of claim 37, wherein the controlling UE comprises the target UE and wherein the target UE performs sensing of the plurality of reference UEs and performs the step of determining the preferred resources, non preferred resources and/or resource conflict or interference based on the sensing.

45. The method of claim 36, wherein the controlling UE comprises one of the plurality of reference UEs or a UE that is not the target UE or one of the plurality of reference UE and wherein the controlling UE performs a sensing operation, wherein the sensing operation comprises one of:
performing sensing of the plurality of reference UEs;
receiving sensing results from the target UE; and
receiving sensing results from the plurality of reference UEs.

46. The method of claim 45, wherein the method comprises:
determining preferred resources, non preferred resources, and/or resource conflict or interference for each of the plurality of reference UEs for use in the SL positioning; and
indicating, in the one or more IUC messages, the preferred resources, non preferred resources and/or resource conflict or interference to each of the plurality of reference UEs;
and wherein the controlling UE performs the step of determining the preferred resources, non preferred resources and/or resource conflict or interference based on the sensing operation.

47. The method of claim 37, wherein the SL positioning requires synchronized transmission by the plurality of reference UEs and/or reception at the target UE of SL Positioning Reference Signals, wherein the step of determining preferred resources, non preferred resources, and/or resource conflict or interference for each of the plurality of reference UEs for use in the SL positioning comprises:
determining the same preferred resources for each of the plurality of reference UEs.

48. The method of claim 47, wherein the step of determining the same preferred resources comprises:
determining an amount of the preferred resources based on:
a number of UEs in a group comprising the target UE and the plurality of reference UEs;
quality of service (QoS) requirements of positioning and/or ranging duration of positioning and/or ranging; and
required positioning and/or ranging measurements and/or methods.

49. The method of claim 46, further comprising:
receiving an indication of one or more SL group-based positioning resource pools from a network node.

50. The method of claim 49, further comprising:
sensing the plurality of reference UEs on the SL group-based positioning resource pools.

51. The method of claim 36, wherein the resource reservation is for side link positioning reference signals (SL-PRS).

52. A method in a network node for enabling performance of sidelink (SL) positioning of a target user equipment (UE) using a plurality of reference UEs, the method comprising:
configuring one or more SL group positioning resource pools that can only be reserved when two or more reference UEs are being used for SL positioning.

53. The method of claim 47, further comprising indicating the SL group positioning resource pools to the target UE and/or the reference UEs utilizing dedicated signalling or system information.

54. A first controlling user equipment (UE) for enabling performance of sidelink (SL) positioning of a target UE using a plurality of reference UEs, the first controlling UE comprising processing circuitry and memory, the memory containing instructions executable by the processing circuitry whereby the first user equipment is operable to:
determine one or more inter-UE coordination message relating to resource reservation for the plurality of reference UEs; and
transmit the one or more IUC messages to the plurality of reference UEs.

55. A network node for enabling performance of sidelink (SL) positioning of a target user equipment (UE) using a plurality of reference UEs, wherein the network node comprising processing circuitry and memory, the memory containing instructions executable by the processing circuitry whereby the network node is operable to:
configure one or more SL group positioning resource pools that can only be reserved when two or more reference UEs are being used for SL positioning.
